(19) United States
(12) Patent Application Publication
(10) Pub. No.: US 2010/0307013 A1
(43) Pub. Date: Dec. 9, 2010

(54) IMPROVEMENT IN AND RELATING TO POWER TOOLS

(76) Inventor: Neil Refson, Kintore (GB)

Correspondence Address: WINSTEAD PC, P.O. BOX 50784, DALLAS, TX, 75201, US

(21) Appl. No.: 12/739,860

(22) PCT Filed: Nov. 7, 2008
(86) PCT No.: PCT/GB2008/051039

§ 371 Date: Aug. 17, 2010

(30) Foreign Application Priority Data
Nov. 10, 2007 (GB) 0722107.0

(51) Int. Cl. B27C 1/10; B27C 9/02; B24B 55/10; B24B 23/02

(52) U.S. Cl. 30/475; 144/252.1; 30/1; 144/38; 451/456

(57) ABSTRACT

To reduce the amount of time required to remove and replace a cover plate or cap (42) in an aperture in power tool housing, a cap assembly (32, 34, 38,42) for coupling to a housing of a power tool is proposed, which aperture facilitates location of a drum within, and removal of the drum from, the housing, the cap assembly (32, 34, 36, 38,42) also being for receiving an end of drive shaft of the tool adapted to drive and rotate the drum relative for the tool housing to remove material from a surface of a workpiece, the cap assembly (32, 34,38,42) comprising: a combined clamping (32, 34, 36, 38, 42) and shaft aliggnment with the shaft ena and a clamping position in engagement with the shaft end. To permit both planing and sanding to br performed using a single drum a drum (16) comprising an at least one mounting channel (56) for receiving an at least one planer blade (96) and the drum being adapted (120) to receive a tubolar sanding element (114), is proposed. To provide efficient extraction of material re-moved by a power tool, a tool housing (14a) having a primary chamber (130) in the housing,a secondary chamber (132) in the housing and an impeller (138) for generating a negative pressure differential between the primary chamber (130) and the secondary chamber (132) is proposed.

The present invention relates to a power tool for use in removing material from a surface of a workpiece. In particular, but not exclusively, the present invention relates to a power tool of a type suitable for use in a planing and/or sanding operation.

Hand operated power tools, in particular hand operated planers, are well known and are produced by many different manufacturers. The most common type of power planers include rotating drums having one or more blades attached to the drum with their cutting edges protruding beyond a circumference of the drum, and located parallel to a main axis of the drum. The planers include fixed rear plates which align with the blade cutting edge once per revolution of the drum, and which support the tool on the newly cut surface of the workpiece. A movable plate is provided in front of the drum with its edges in line with, and surface parallel to, the rear plate. The front plate is height adjustable relative to the rear plate, and the height of the front plate is set a predetermined amount higher than the cutting edge of the blade, to govern the depth of cut made. The combination of the front and rear plates allows the tool to be controlled safely and the production of an accurate, flat, square surface of a predetermined depth.

Whilst known power planers typically remove material from a surface of a workpiece relatively quickly, they do suffer from a number of disadvantages. In particular, power planers are only suitable for planing wood, and if the planer blades strike a metal object, such as a nail or screw, they can be seriously damaged, requiring replacement. Also, when cutting along a surface extending transverse to the grain of a piece of wood, the planer blades can cause splintering at the edges and end of the surface, thereby degrading perpendicular surfaces.

Other types of tools used for removing material from a surface of a workpiece include abrading tools such as power sanders. Current power sanders are less likely to be seriously damaged through encountering a metal object, and are also less likely to cause deterioration of adjacent surfaces at an edge/end of a workpiece surface. However, power sanders remove material at a much lower rate than power planers. Furthermore, when sanding a narrow workpiece edge with a conventional hand operated power sander, such as a belt or orbital sander, it is extremely difficult to produce a flat finish without curvature in both dimensions of the surface, because the abrading surface of the sander is unsupported.

As current power planers and sanders have a number of inherent advantages and disadvantages, it is important to carefully consider the choice of tool type in order to produce the most accurate, smooth finish in the shortest possible time. Consequently, in many cases tools of both types are needed, adding to the time and/or cost of the job.

Providing a power planer in which the planing drum could be replaced with an abrasive, sanding drum would solve the disadvantage of having to provide separate tools. Tools of this type would be useable with a wide variety of materials and composites, without splintering the workpiece or damaging the tool, and should also remove a predetermined amount of material whilst leaving a flat square surface. However, whilst a tool of this type has been proposed in U.S. Pat. No. 2,540,258 to Harris, published in 1951, the principle is practically unknown in the worldwide power tool market. The reasons for this are most likely the increased technical difficulties involved in manufacturing such a tool.

These difficulties include that, in manufacturing the tool, access must be provided for a user to subsequently change the abrasive drum, when required. The easiest method in which to achieve this would be to have a hole in the main casing, allowing a sanding drum or over-cylinder to be slid off a drum of the planer. The problem with this is that one drum end bearing would also need to be removed.

German Patent Publication No. 3541728 to Festo K G illustrates a possible solution to this problem, by improving the mounting on the other end of the drum. However, this is an expensive solution to the problem and significantly increases the mass of the tool. In addition, mounting the drum in this way prevents the same drum from being used both as a sander and as a planer, because the bearing mechanism is contained in the drum with the result that there is insufficient room for planer blades.

Another method of mounting the drum is to have one end bearing contained in a removable cap, as disclosed in European Patent Publication No. 0878280 to Trevisiol. However, as the end bearings must be very rigid and positioned accurately, the method of mounting taught by Trevisiol results in the tool suffering from significant increased vibration and inaccuracy of cut, unless many peripheral fixings are used. The requirement to secure and adjust multiple fixings means that it takes a long time to change sanding cylinders, which can be extremely frustrating to the operator.

Further difficulties include that dust removal would be a problem. In more detail, a conventional planer generally channels the exhaust from the motor cooling fan through a compartment above the planing drum, to push the planing waste out of the side of the tool. This system relies on the waste having sufficient mass to be thrown, by centripetal force, into said compartment. Unfortunately, sanding waste is much finer, with the result that it would not have sufficient energy to enter the exhaust airflow, and would instead be scattered in all directions by stray exhaust and drum airflow. The fine dust would then become a significant health hazard. Consequently, it would be essential to employ a separate powered dust extractor, which would be inconvenient and would add to costs.

A further difficulty is that planing drums typically revolve at over 10,000 rpm and therefore need to be accurately balanced in order to avoid significant vibration. If a planing blade of a current power planer requires to be replaced, an identical blade is fitted so that tool balance is not disturbed too much (provided the replacement blade is set accurately). If an abrasive cylinder were fitted to the drum, it would need to be changed often and conventional mounting methods would often result in inaccurate positioning. The resulting vibration would cause significant operator discomfort, fatigue and potentially permanent partial disability.

It is amongst the objects of embodiments of the present invention to obviate or mitigate at least one of the foregoing disadvantages.

According to a first aspect of the present invention, there is provided a power tool comprising:

a tool housing;

a drum adapted for removing material from a surface of a workpiece, the drum adapted to be releasably mounted within the housing;

a drive shaft adapted to drive and rotate the drum relative to the housing, for removing material from the workpiece surface;

an aperture in the tool housing for facilitating location of the drum within, and removal of the drum from, the housing; and

a cap assembly for coupling to the tool housing to close the aperture, the cap assembly adapted to receive an end of the drive shaft to facilitate mounting of the drum within the housing;

wherein the cap assembly comprises a combined clamping and shaft alignment mechanism which is movable between a release position out of engagement with the shaft end and a clamping position in engagement with the shaft end, and wherein the mechanism is arranged to automatically align the shaft and thus the drum on an optimal rotation axis during movement towards the clamping position.

By providing a power tool having a cap assembly with such a clamping and shaft alignment mechanism, the problems with prior power tools having multiple fixings, where it is necessary to secure and carefully adjust the multiple fixings, are overcome. In particular, in the tool of the first aspect of the present invention, the mechanism automatically aligns the shaft and drum on the optimal rotation axis during movement towards the clamping position. It will be understood that the optimal rotation axis of the drum/shaft is that which results in minimal vibration of the drum/shaft in use during rotation, with the result that the tool is balanced and overall vibrations reduced. Also, such aligning of the shaft is important to ensure that the sanding cylinder is accurately aligned with the base plate for accurate sanding. Furthermore, although location of a bearing in which the shaft is mounted out of position may not inherently increase vibration, vibration may occur in the event that the bearing is not rigidly mounted onto the tool housing. The cap assembly of the first aspect of the invention may permit such rigid mounting.

The cap assembly may be adapted to clamp a wall of the housing, and may comprise a first clamping member adapted to abut an outer surface of the wall of the housing and a second clamping member adapted to abut an inner wall of the housing. Thus by drawing the two clamping members together, which occurs during movement of the mechanism towards the clamping position, the wall is clamped between the members and the cap assembly thereby secured to the housing, to cover the aperture. The mechanism may comprise a threaded securing member which, when rotated, draws the first and second clamp members together to clamp the housing wall. The securing member may be adapted to receive the shaft end and may comprise or carry a bearing within which the shaft end is received, to facilitate rotation of the shaft relative to the/a main part of the securing member. The second clamping member may comprise a nut threadably coupled to the threaded securing member and which advances or retracts along the securing member when rotated. In this fashion, the second clamping member may be drawn towards the first clamping member when the securing member is rotated, to clamp the cap assembly to the housing. The second clamping member may also comprise a plate defining an abutment surface for abutting the housing wall, which plate may be adapted to engage in a slot, track, channel or the like formed in the housing wall. Engagement of the plate within the slot restricts rotation of the plate during rotation of the securing member.

One of the cap assembly and the housing may define an at least one alignment protrusion or member such as a rib or the like, and the other one of the cap assembly and the housing may define a corresponding at least one alignment recess, channel, groove, indentation or the like, engagement between the protrusion and the recess facilitating alignment of the shaft and drum on the optimal rotation axis. Preferably, the cap assembly comprises a cap shaped to cover the aperture, the cap defining one of the alignment protrusion and the recess, whilst the other one of the alignment protrusion and the recess is defined by a wall of the housing. Preferably also, at least one surface of the at least one protrusion and at least one surface of the at least one recess is inclined. Providing the protrusion/recess with such inclined surfaces may facilitate bringing of the shaft/drum into alignment on the optimal rotation axis in that the inclined surfaces permit sliding interaction between the cap assembly and the housing, to bring the shaft/drum into the desired alignment as the mechanism is moved towards the clamping position. Additionally, this arrangement of protrusion and recess may also serve to prevent lateral movement between the tool housing and a bearing carried by the cap assembly, thereby effectively improving the strength of the tool housing (with the cap assembly coupled) and thus reducing vibration in use of the tool.

The cap assembly may also comprise a cap portion adapted to close a secondary aperture formed in the housing, which secondary aperture opens on to a dust extraction chamber of the tool. Providing such a secondary aperture, and closing the aperture with the cap portion of the removable cap assembly, thereby facilitates access to the chamber for cleaning purposes.

The drum may be located such that a main axis of the drum is perpendicular to a main axis of the tool, and the aperture may be formed in a side wall of the housing.

According to a second aspect of the present invention, there is provided a cap assembly for coupling to a housing of a power tool to close an aperture of the tool which aperture facilitates location of a drum within, and removal of the drum from, the housing, the cap assembly also being for receiving an end of a drive shaft of the tool adapted to drive and rotate the drum relative to the tool housing to remove material from a surface of a workpiece, the cap assembly comprising:

a combined clamping and shaft alignment mechanism which is movable between a release position out of engagement with the shaft end and a clamping position in engagement with the shaft end, the mechanism arranged to automatically align the shaft and thus the drum on an optimal rotation axis during movement towards the clamping position.

Further features of the cap assembly of the second aspect of the present invention are defined above within and/or in relation to the first aspect of the invention.

According to a third aspect of the present invention, there is provided a power tool for removing material from a surface of a workpiece, the tool comprising:

a tool housing; and

a drum adapted for rotation relative to the housing, the drum comprising an at least one mounting channel for receiving an at least one planer blade to remove material from the workpiece surface in a planing action when the drum is rotated, and the drum being adapted to receive a tubular sanding element which element is located around the drum and which defines a sanding surface for abrading the workpiece surface when the drum is rotated;

wherein, in use, the tool is adapted to be configured for a planing operation by mounting an at least one planer blade in the at least one mounting channel and to be configured for a sanding operation by mounting of a tubular sanding element around the drum.

Providing a tool having a drum which can be configured for both a planing and a sanding operation permits both planing and sanding to be performed using a single tool, thereby addressing problems with prior tools whereby multiple tools are required to carry out different operations, and/or where a complex operation to changeover a planing type drum for a sanding type drum must be performed. Furthermore, by providing a tool with a drum which may be configured for both planing and sanding operations, the drum may be permanently fixed in position, and thus may be dynamically balanced by the manufacturer, which results in lower vibration.

The drum may comprise a plurality of channels, each channel adapted to receive a respective at least one planer blade.

The drum may be dimensioned to be a close-fit with the tubular sanding element for driving and rotating the element. The drum may define an abutment surface for abutment with the tubular sanding element in a friction fit, for driving and rotating the element. However, in a preferred embodiment, one of the drum and the tubular sanding element may define a drive protrusion such as a rib, and the other one of the drum and the tubular sanding element may define a corresponding drive recess, channel or the like adapted to receive the drive protrusion. Providing such a drive protrusion and recess may restrict slippage of the sanding element on the drum, in use. Preferably, there are a plurality of drive protrusions and corresponding recesses. The tool may comprise an at least one blade cartridge adapted to be releasably mounted in the drum recess. Providing such a blade cartridge may facilitate mounting of the blade on the drum and release of the blade, such as for replacement and/or maintenance.

The blade cartridge may comprise a mounting member adapted to be located in the drum channel, an at least one planer blade and a clamping member for clamping the blade to the mounting member. The clamping member may be configured to exert a clamping force on the blade to clamp the blade to the mounting member.

The mounting member and the clamping member may define respective apertures which apertures align when the clamping member is coupled to the mounting member and the cartridge located in the drum channel. The aligned apertures may be shaped to receive a locking element such as a threaded bolt or screw, for locking the cartridge to the drum. The mounting member may define a blade mounting surface shaped to receive the blade, and may comprise a locating protrusion such as a rib, ridge or the like shaped to engage a corresponding locating recess in the blade, which may facilitate location of the blade in the correct position relative to the mounting member. The clamping member may be shaped to define a clamping surface adapted to abut the blade to clamp the blade against the mounting surface of the mounting member. The clamping member may comprise a protrusion defining a pivot point about which the clamping member pivots when the cartridge is secured to the drum, to exert a compressive clamping load on the blade. In this fashion and in combination with providing a locating protrusion/recess on the mounting member/blade, when the cartridge is secured to the drum, the clamping member may clamp the blade against the mounting member and thereby automatically secure the blade in the correct position, thereby avoiding problems of prior power planers in which careful and time-consuming adjustment of replacement blades is required.

The tool may comprise a drive shaft for driving and rotating the drum, and a mounting assembly for mounting the drum on the drive shaft. The mounting assembly may comprise first and second locating elements such as washers, the first and second locating elements adapted to engage respective first and second ends of the drum and to be mounted on the drive shaft for thereby locating the drum on the shaft. The mounting assembly may also comprise a threaded locking nut adapted to engage a threaded portion of the drive shaft for securing the drum to the shaft. The locating elements may be dimensioned to be a close-fit on the shaft so as to locate the drum as accurately as possible, thereby ensuring that the drum is well balanced, to minimise vibration in use of the tool. The locating elements may also be adapted to engage the tubular sanding element, and may comprise abutment surfaces which are preferably inclined (relative to an axis of the drum) for engaging corresponding surfaces on the tubular sanding element. Providing such abutment surfaces, particularly inclined surfaces, facilitates alignment of the sanding element and thus minimises vibration in use of the tool. Additionally, the abutment surfaces may allow a larger gap to be provided between an outer surface of the drum and an inner surface of the sanding element, for easier fitting thereof.

According to a fourth aspect of the present invention, there is provided a combination planer and sander assembly for a power tool, the assembly comprising:

at least one planer blade;

a tubular sanding element defining a sanding surface;

a drum having an at least one mounting channel for receiving the at least one planer blade;

wherein the drum is adapted to receive the tubular sanding element, the element located around the drum;

and wherein, in use, the drum is adapted to be configured for a planing operation by mounting of the at least one planer blade in the at least one mounting channel and to be configured for a sanding operation by mounting of the tubular sanding element around the drum.

It will be understood that many features of the planer and sander assembly of the fourth aspect of the present invention are common with the tool of the third aspect of the invention. Accordingly, further features of the assembly of the fourth aspect of the invention are defined above within and/or in relation to the third aspect of the invention.

According to a fifth aspect of the present invention, there is provided a power tool comprising:

a tool housing;

a primary chamber in the housing for receiving a drum adapted for removing material from a surface of a workpiece;

a secondary chamber in the housing;

an impeller for generating a negative pressure differential between the primary chamber and the secondary chamber, for encouraging material removed from the workpiece surface by the drum to pass from the primary chamber and into the secondary chamber; and

an opening formed in a wall of the housing provided between the primary and secondary chamber and through which opening removed material passes into the secondary chamber;

wherein the opening extends in a direction along a length of the drum, and wherein the dimension of the opening in the length direction of the drum is at least equal to a length of an operative surface of the drum.

Providing a tool in which an impeller is provided in a secondary chamber in communication with a primary chamber through an opening in a wall of the housing, and in which the impeller generates a negative pressure differential between the primary chamber and the secondary chamber, provides efficient extraction of material removed from the workpiece surface from the primary chamber, when compared to prior power tools. Furthermore, the removed material may be larger chippings such as those removed from the surface by a planer blade, as well as finer dust generated in a sanding operation.

It will be understood that the impeller generates a negative pressure differential between the primary chamber and the secondary chamber in that the air pressure in the secondary chamber is lower than that in the primary chamber, creating a suction effect to assist in drawing the removed material from the primary chamber.

The power tool may be a power planer, a power sander or a combination power planer and sander.

The opening may be elongate and may be arranged on a tangent of the drum, to encourage removed material ejected from the drum to pass through the opening and into the secondary chamber.

The secondary chamber may comprise an outlet for passage of removed material from the chamber, and the impeller may be arranged to direct material through the outlet. The impeller may be located in a flow path extending from the drum, through the opening into the secondary chamber, and from the secondary chamber into and through the outlet. Accordingly, the impeller may be adapted to exert a force on the removed material to eject the material from the secondary chamber.

Alternatively, the impeller may be located out of the flow path and may be located in a portion of the secondary chamber which is isolated from the flow path. The impeller may be arranged to direct a jet or stream of air past the opening and into the outlet, to draw the removed material from the primary chamber through the opening.

The impeller may comprise a plurality of impeller blades, and may comprise two sets of impeller blades, the sets provided on opposite sides of the impeller. In embodiments of the invention, the impeller is a radial flow impeller. However, in alternative embodiments, the impeller is an axial flow impeller, and may take the form of a fan/propeller. The tool may comprise a plurality of impellers.

The operative surface of the drum may be a portion of a surface of the drum adapted to actively facilitate removal of material from the workpiece surface. Accordingly, the operative surface may be that portion of the drum surface which carries or supports a planer blade or sanding surface, and/or the effective area of the drum over which a material removal activity occurs. It will be understood that the operative surface may therefore be the whole or a part of the surface area of the drum.

The above-described features of the present invention may be provided in combination in a single power tool. Accordingly, it will be understood that the invention defined by any one of the first to fifth aspects defined above may incorporate one or more features of a remaining one or more of the remaining aspects.

The drum may comprise a plurality of drum segments which together form the drum, each segment being generally cylindrical and with a compressible member, such as an elastomeric O-ring, located between adjacent segments, for abutting a material removing element such as a tubular sanding element. The drum segments may be adapted to be located on a drive shaft and to be locked in position by a locking member such as a threaded nut, whereupon the compressible member is compressed and expanded radially to abut the sanding element or the like.

In a preferred embodiment, the drum comprises three drum segments with compressible members located between the adjacent segments. In this fashion, a secure abutment with the sanding element or the like is provided, resisting slippage of the element relative to the drum.

The drum segments may together define one of a keyway and a key, for engaging with a corresponding key or keyway on a drive shaft for driving and rotating the drum.

Embodiments of the present invention will now be described, by way of example only, with reference to the accompanying drawings, in which:

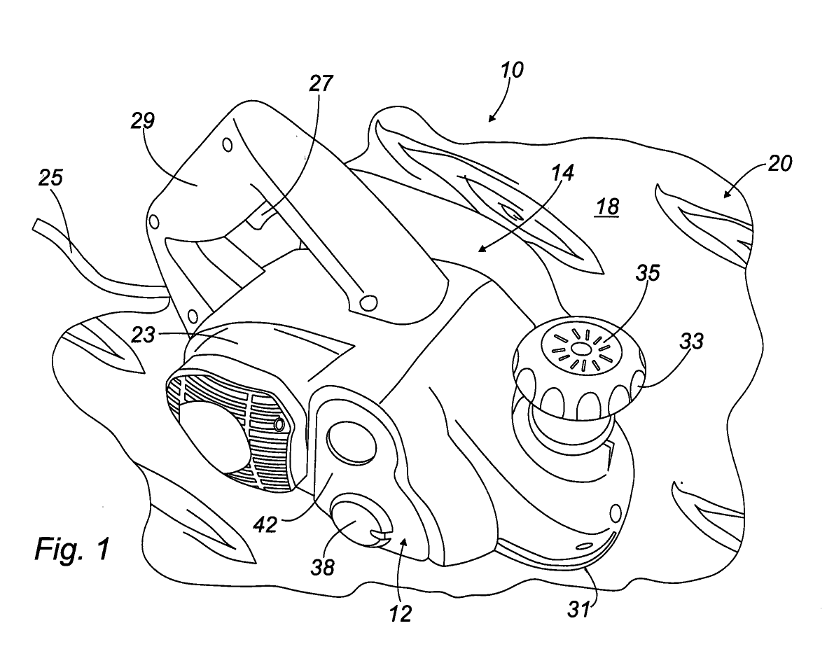

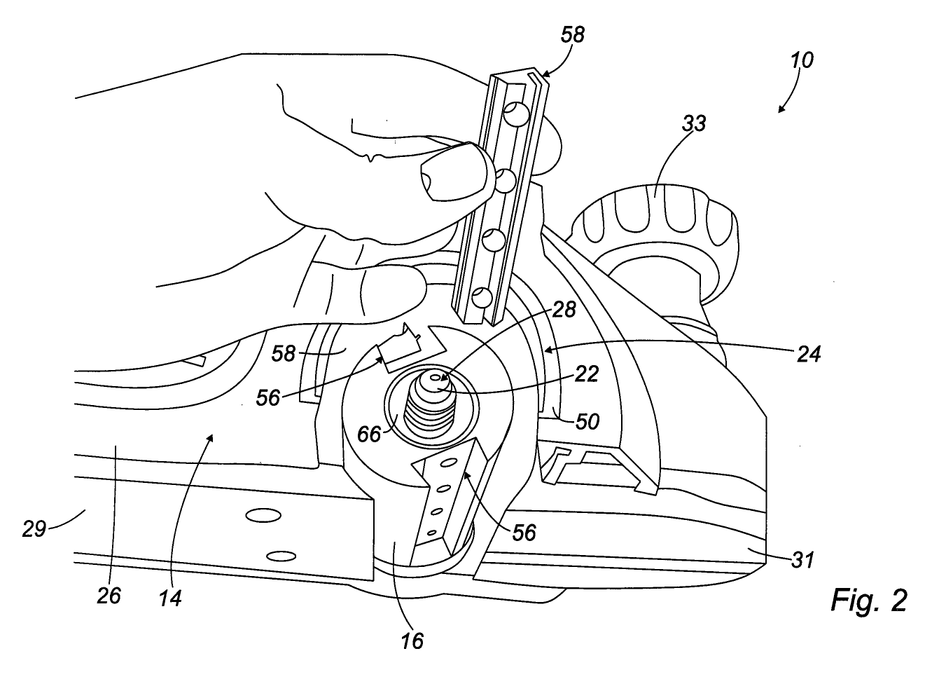

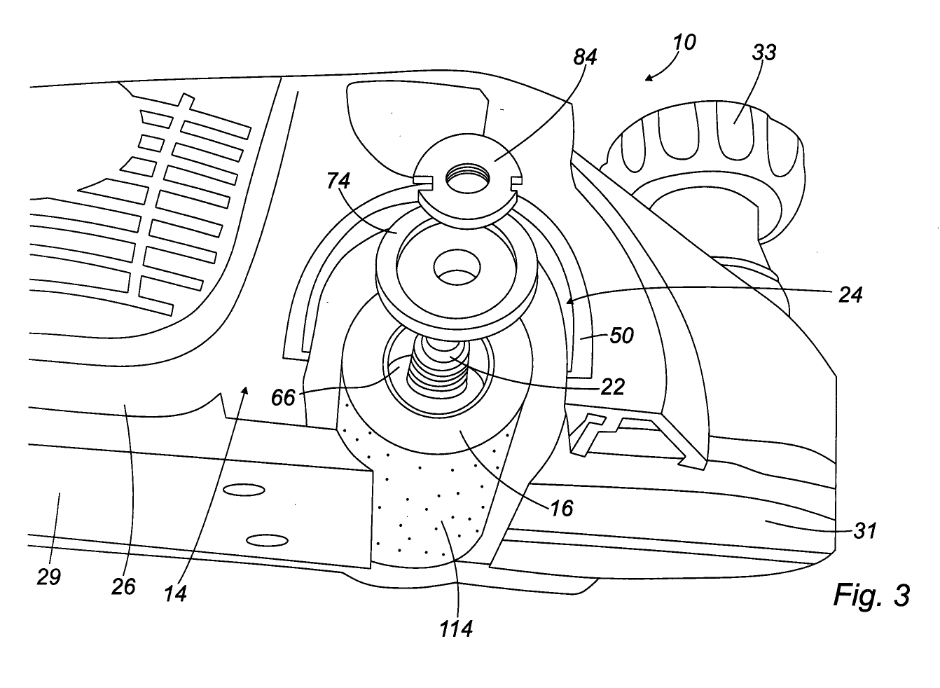

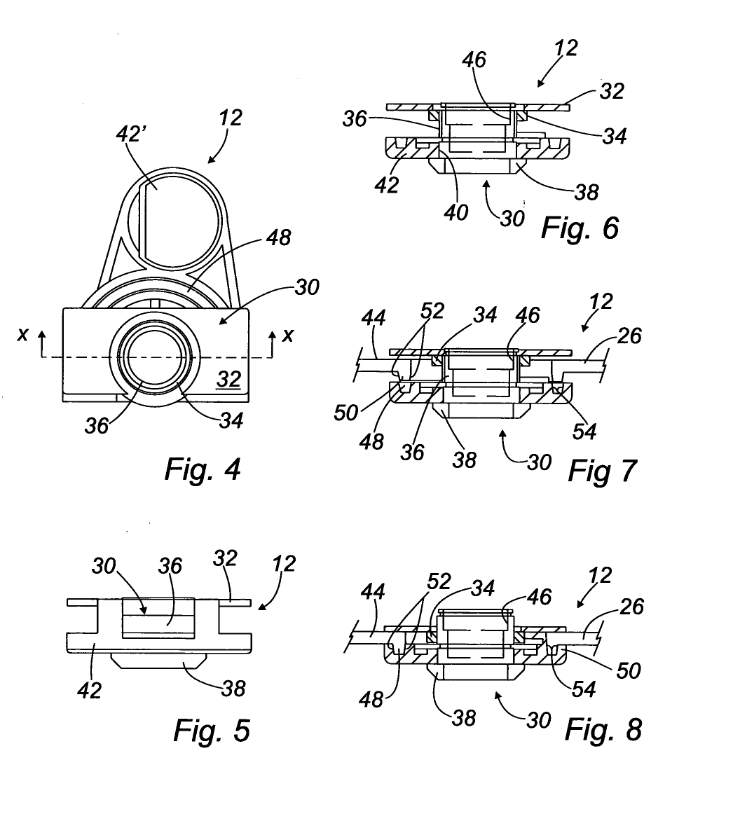

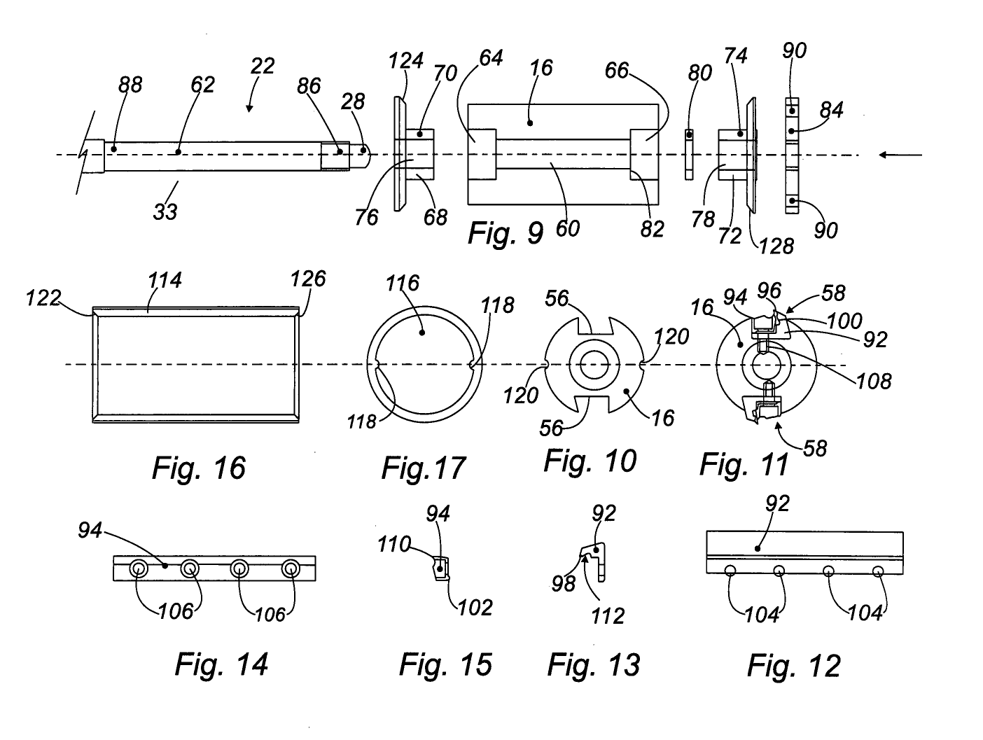

FIG. 1 is a perspective view of a power tool in accordance with an embodiment of the present invention;

FIG. 2 is a perspective view of the tool shown in FIG. 1 taken from a different angle, and with an end cap assembly of the tool removed;

FIG. 3 is a view similar to FIG. 2 with planer blade cartridges of the tool removed and replaced with a tubular sanding element;

FIG. 4 is an inside view of the cap assembly shown in FIG. 1;

FIG. 5 is a bottom view of the cap assembly of FIG. 4, showing the cap assembly in a release position;

FIG. 6 is a cross-sectional view of the cap assembly of FIG. 4, taken about the line X-X of FIG. 4;

FIGS. 7 and 8 show the cap assembly of FIG. 4 during coupling to a wall of a housing of the tool shown in FIG. 1, FIG. 7 showing the cap assembly in the release position of FIG. 5 and FIG. 8 following movement to a clamping position;

FIG. 9 is a schematic exploded view of part of the tool of FIG. 1 showing a drum of the tool and its mounting in the tool in more detail;

FIG. 10 is an end view of the drum of FIG. 9, showing mounting channels for planer blade cartridges;

FIG. 11 is a view of the drum similar to FIG. 10 and showing the drum following location of planer blade cartridges in the channels;

FIGS. 12 and 13 are front and end views, respectively, of a mounting member part of the planer blade cartridges shown in FIG. 11;

FIGS. 14 and 15 are front and end views, respectively, of a clamping member forming part of the cartridges shown in FIG. 11;

FIGS. 16 and 17 are longitudinal sectional and end views, respectively, of a tubular sanding element which may be mounted on the drum shown in FIGS. 9 and 10 in place of the planer blade cartridges of FIG. 11;

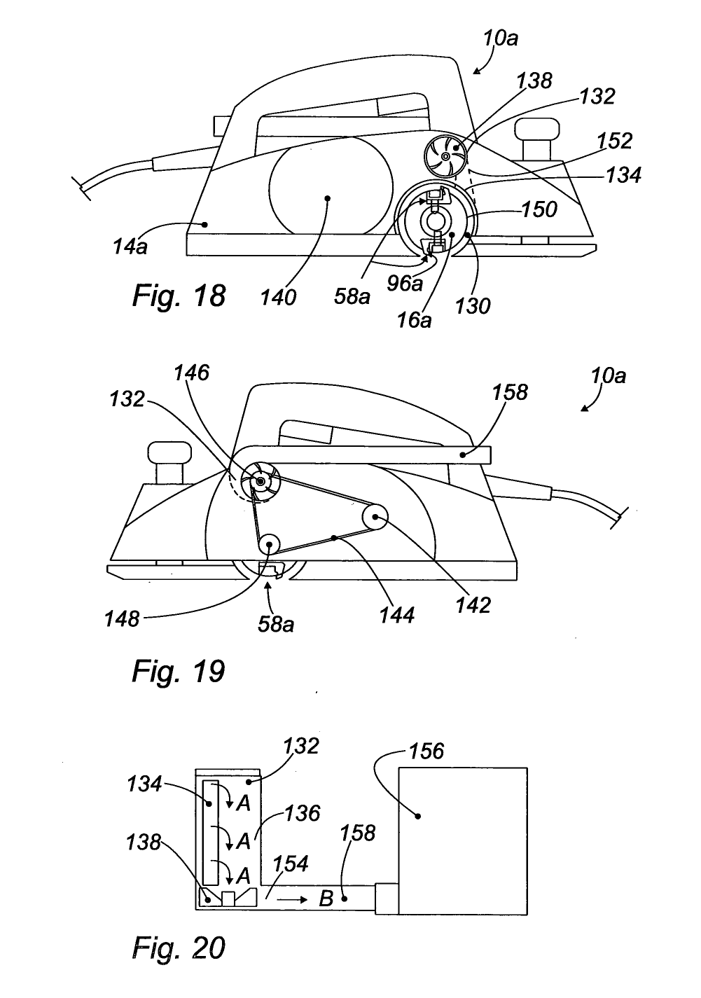

FIGS. 18 and 19 are schematic right side and left side views of a tool in accordance with an alternative embodiment of the present invention;

FIG. 20 is a schematic plan view of part of the tool of FIGS. 18 and 19;

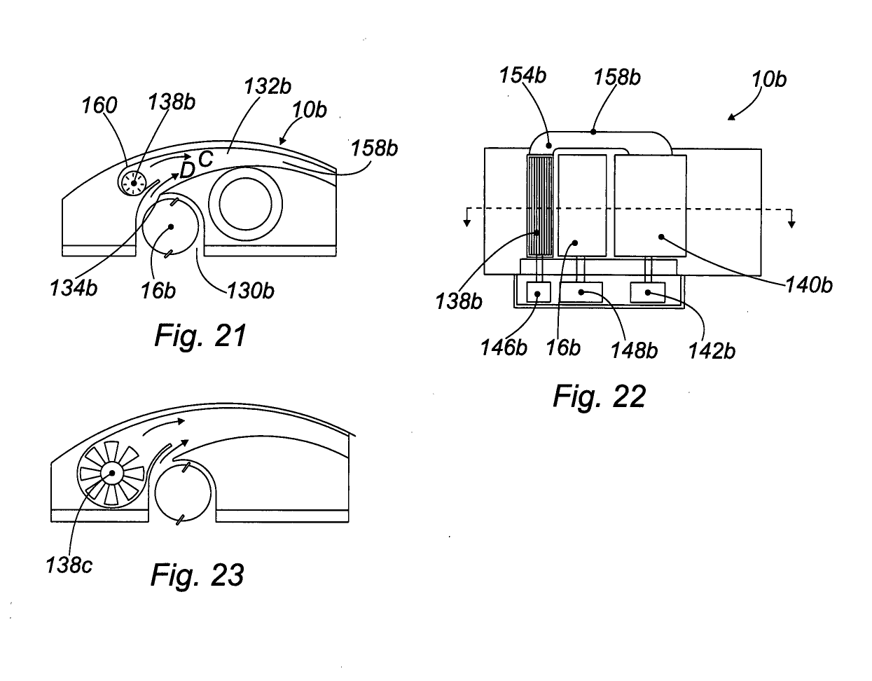

FIGS. 21 and 22 are schematic side and perspective views, respectively, of a part of a tool in accordance with a further alterative embodiment of the present invention;

FIG. 23 is a schematic side view illustrating a variation on the tool shown in FIGS. 21 and 22;

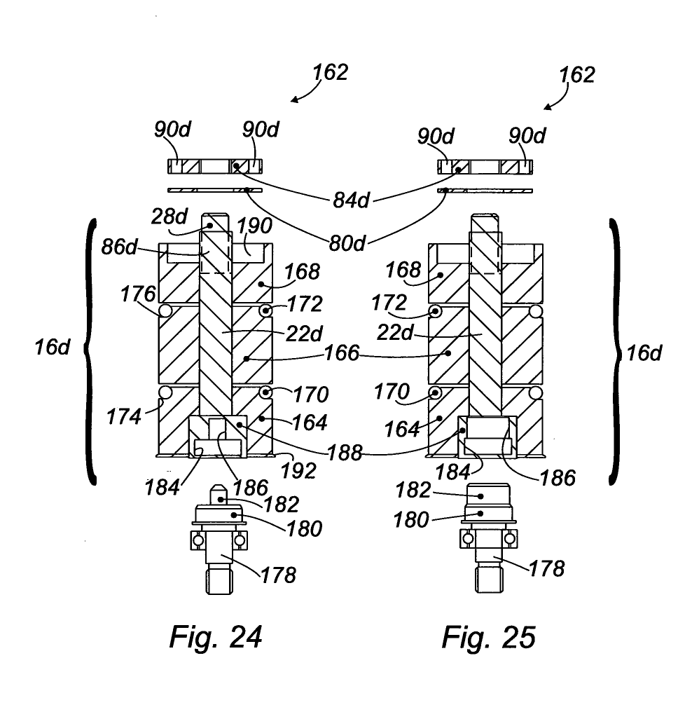

FIG. 24 is a view of a sanding assembly including a drum, the assembly suitable for inclusion in any one of the tools of FIGS. 1 to 23;

FIG. 25 is a view of the sanding assembly of FIG. 24 rotated through 90 degrees;

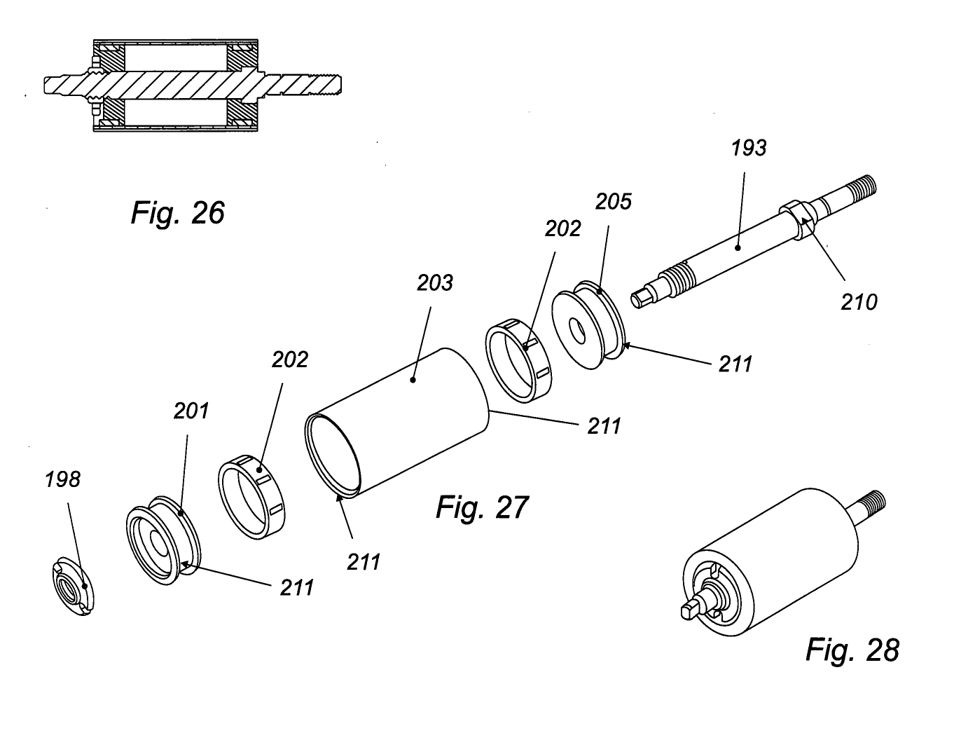

FIG. 26 shows a sectional view of an alternative sanding drum;

FIG. 27 is an exploded view showing the components of the alternative sanding drum;

FIG. 28 is an isometric view of the alternative sanding drum;

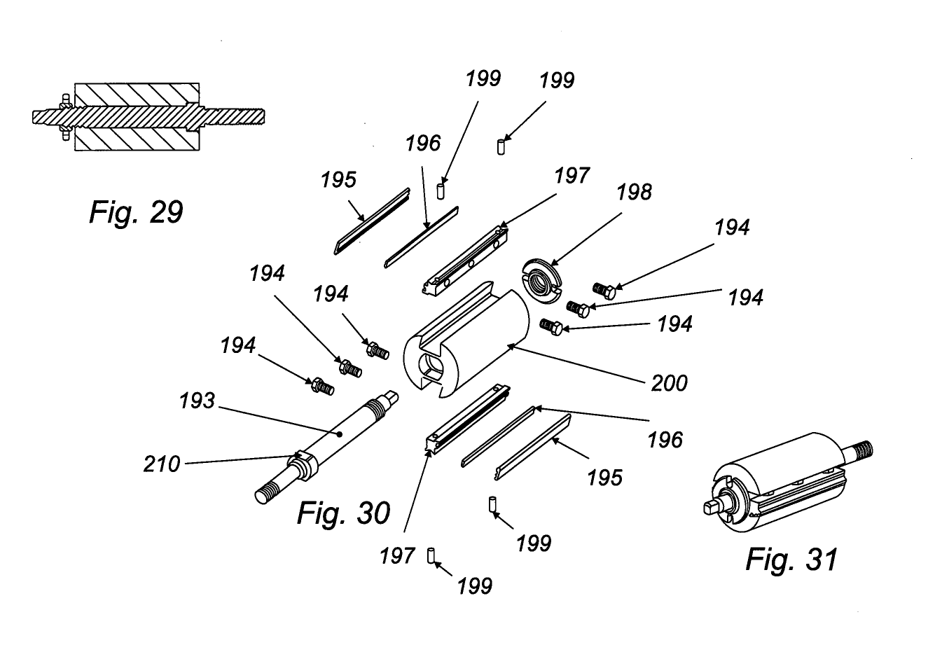

FIG. 29 shows an alternative planning drum fitted to the shaft used for the alternative sanding cylinder;

FIG. 30 is an exploded view showing the components that make up the alternative planning drum;

FIG. 31 is an isometric view of the alternative planning drum;

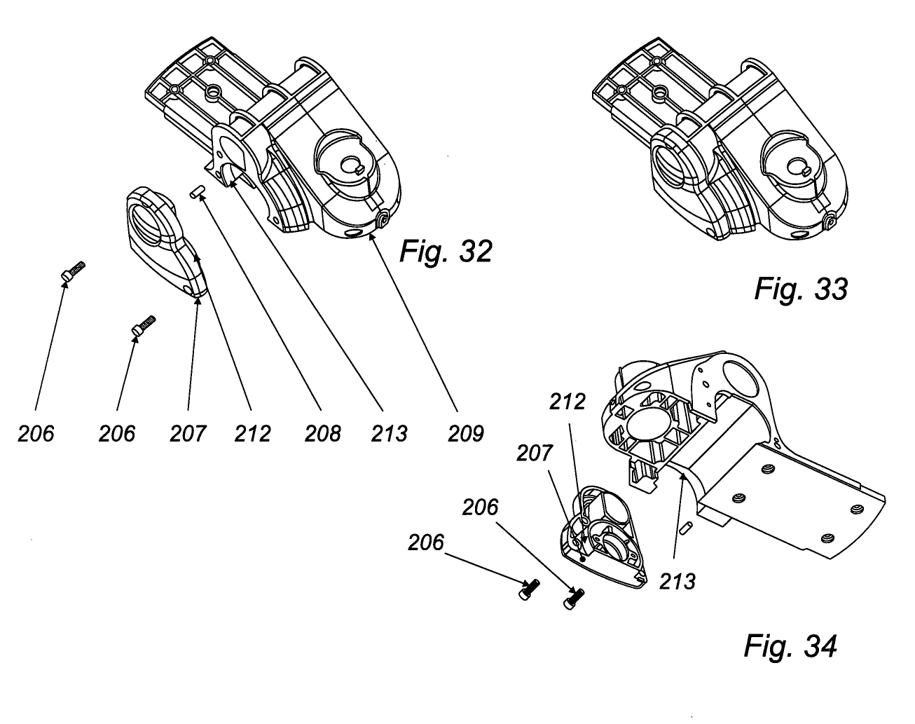

FIG. 32 shows the alternative end cap components;

FIG. 33 is an assembled view of the alternative end cap arrangement, and

FIG. 34 is a further view of the alternative end cap arrangement.

Turning firstly to FIG. 1, there is shown a perspective view of a power tool in accordance with an embodiment of the present invention, the power tool indicated generally by reference numeral 10. The tool 10 takes the form of a combined planer and sander.

The tool 10 is also shown in FIG. 2, which is a perspective view of the tool 10 shown in FIG. 1 taken from a different angle and with an end cap assembly 12 removed, and in FIG. 3, which is a view similar to FIG. 2. In general terms, the tool 10 comprises a tool housing 14, a drum 16 for removing material from the surface 18 of a workpiece 20 and a drive shaft 22 adapted to drive and rotate the drum 16 relative to the housing 14. A motor (not shown) is located in a part 23 of the housing 14, coupled to an electrical power supply via a supply cable 25, and serves for driving and rotating the drum 16. The tool is activated by a user depressing a trigger 27 on a handle 29 of the tool. The tool 10 also includes a fixed rear base plate 29 and a height adjustable front plate 31. The height of the front plate 31 is adjusted by rotating an adjusting and tool grip knob 33, a readout of the selected depth indicated on a depth scale 35.

In use of the tool 10, the knob 33 is rotated to select the desired depth of material to be removed, as indicated by the gauge 35. Setting the material depth governs the height of the front plate 31 relative to the fixed rear plate 29, and determines the extent to which the drum 16 is exposed. A material removal operation is carried out by then introducing the tool 10 to an edge of the workpiece surface 18 with the front plate 31 resting on the surface. The tool is then activated to drive and rotate the drum 16, which will remove a depth of material from the surface equivalent to the set depth. The tool 10 is advanced along the workpiece surface, the fixed rear plate 27 resting on the newly exposed portion of the surface 18 and thereby supporting the drum 16.

An aperture 24 is formed in side wall 26 of the housing 14 for facilitating location of the drum 16 within the housing 14, and removal of the drum 16 from the housing 14. The cap assembly 12, which is shown in FIG. 1, is for coupling to the housing 14 to close the aperture 24, and receives an end 28 of the drive shaft 22, to facilitate mounting of the drum 16 within the housing 14 as will be described in more detail below, the cap assembly 12 thus provides access to the drum 16 to facilitate, inter alia, changeover of the tool 10 from a planer, shown in FIG. 2, to a sander, shown in FIG. 3.

The cap assembly is shown in more detail in FIG. 4, which is an inside view of the cap assembly, and in FIG. 5, which is a bottom view. The cap assembly 12 comprises a combined clamping and shaft alignment mechanism 30 which is moveable between a release position out of engagement with the end 28 of the drive shaft 22, and a clamping position in engagement with the shaft end 28. Additionally, the mechanism 30 is arranged to automatically align the shaft 22 and thus the drums 16 on an optimal rotation axis during movement towards the clamping position. By aligning the shaft 22 and drum 16 on the optimal rotation axis, vibration is reduced compared to prior tools.

The cap assembly 12 is also shown in FIG. 6, which is a cross-sectional view taken about the line X-X of FIG. 4, and which shows the cap assembly 12 in the release position. The cap assembly 12 is further illustrated in FIGS. 7 and 8 during coupling to the wall 26 of the housing 14, FIG. 7 showing the cap assembly 12 in the release position and FIG. 8 following movement to the clamping position.

The cap assembly clamping and shaft alignment mechanism 30 comprises a plate 32 to which a threaded nut 34 is mounted, and a threaded securing member 36 which has a head 38 and which extends through a passage 40 in a cap 42 of the cap assembly 12.

The securing member 36 is rotatable relative to the cap 42 and the threaded nut 34 mounted on the threaded portion of the securing member 36. In this fashion, when the cap assembly 12 is mounted on the housing 14 and the securing member 36 rotated, the nut 34 and thus the plate 32 is advanced or retracted along the securing member. FIGS. 5, 6 and 7 show the cap assembly 12 in the release position, as described above, in which the plate 32 and nut 34 is spaced at a maximum distance along a length of the securing member 36 away from the cap 42. With the plate 32 and nut 34 in this position, the cap assembly 12 is introduced to the housing 14, the plate 32 positioned inside the housing 14 adjacent an inner surface 44 of the housing wall 26, located in a slot (not shown) in the wall. In this position, the securing member 36 is spaced from the drive shaft end 28. The securing member 36 carries a bearing assembly (not shown) in a recess 46, which bearing assembly is shaped to receive the drive shaft end 28. With the cap assembly 12 located as shown in FIG. 7, the securing member 36 is rotated in a clock-wise direction such that the threaded nut 34 advances along the securing member towards the cap 42, thereby drawing the plate 32 towards the cap 42 and clamping the housing wall 26 therebetween. The cap assembly 12 is then securely coupled to the housing 14. During this movement towards the closed position of FIG. 8, the securing member 36 is translated towards the drive shaft 22 in a direction along a length of the shaft, such that the drive shaft end 28 becomes securely located within the bearing carried by the securing member 36. Accordingly, the drive shaft end 28 is then firmly located in and supported by the cap assembly 12, and is rotatable relative to the securing member 36 by virtue of the bearing assembly.

The mechanism 30 also comprises a channel 48 formed in the cap 48, which channel 48 is generally inverse U-shaped when viewing the cap from the inside as shown in FIG. 4. A corresponding protrusion in the form of a rib 50 is provided on the housing wall 26 and which is shaped to mate with the channel 48. Indeed, as best shown in FIG. 7, the rib 50 has inclined side walls 52 and the recess corresponding inclined walls 54. In this fashion, as the plate 32 is drawn along the securing member 36 towards the cap 42, the cap 42 is brought to a position where the drive shaft 22 is located on the optimal rotation axis. Accordingly, the drum 16 is automatically aligned on the optimal axis, reducing vibration in use of the tool 10 when compared to prior tools.

When it is desired to release the cap assembly 12 to gain access to the drum 16, the securing member 36 is rotated in an anti-clockwise direction, returning the cap assembly to the release position of FIG. 7, whereupon the cap assembly 12 may be slid out of the housing 14. Such access to the drum 16 is required in order to change over the tool 10 from a plaining to a sanding function, as will now be described.

Returning to FIG. 2, it will be noted that the drum 16 includes two mounting channels 56 which extend along the length of the drum 16. These channels 56 are each shaped to receive planer blade cartridges 58, which will be described in more detail below. The drum 16, which is shown in more detail in the schematic exploded view of FIG. 9, includes a central shaft 60 shaped to receive a main portion 62 of the drive shaft 22 in a sliding-fit, and two cylindrical recesses 64 and 66 provided at opposite ends of the drum. The recess 64 is shaped to receive a boss 68 on a first locating element, in the form of a washer 70, in a tight push-fit. The recess 66 at the opposite end of the drum 16 is, however, shaped to receive a boss 72 of a second locating element, also in the form of a washer, in a sliding fit, the purpose of which will become clear below. The first washer 70 includes a central shaft 76 which is shaped to be a tight push-fit on the shaft main portion 62, whilst the second washer 74 includes a central shaft 78 which is shaped to be a sliding fit on the main portion 62. Finally, an elastomeric 0-ring 80 is provided in the drum recess 66, sandwiched between a face 82 of the recess 66 and the second washer 74, and a locking nut 84 is provided outermost, and which threads on to a threaded portion 86 of the shaft 22.

In use, the drum 16 is assembled on the drive shaft 22 as follows. The first washer 70 is pushed into the drum recess 64, and the washer 70 and drum 16 then located on the drive shaft main portion 62 in a push-fit. The first washer 70 is advanced along the shaft main portion 62 until it comes into abutment with a shoulder 88 on the shaft 22. In this position, the shaft threaded portion 86 protrudes into the drum recess 66, and the shaft end 28 protrudes from the drum 16. The O-ring 80 is then located over the shaft 22, the second washer 74 slid into the recess 66 over the shaft end 28, and the locking nut 84 threaded onto the portion 86 of the shaft 22. The drum 16 is then rotated to align drum locking holes (not shown) with a hole in an opposite side wall of the housing 14, and a locking tool inserted to restrain the drum 16 against further rotation. A special spanner (not shown) having protrusions which engage in holes 90 in the locking nut 84 is then used to rotate the locking nut 84, to lock the drum 16 onto the shaft 22. The cap assembly 12 may then be coupled to the housing 14 in the fashion described above, following which the tool 10 is ready for use.

The planer blade cartridges 58 discussed above will now be described in more detail. Referring to FIG. 10, there is shown an end view of the drum 16 showing the mounting channels 56. The cartridges 58 are shown following location in the channel 56 in the schematic view of FIG. 11, and the component parts of the cartridges 58 shown in FIGS. 12 to 15. Each cartridge 58 includes a mounting member 92 which is generally L-shaped in cross-section and which is also shown in the front and end views of FIGS. 12 and 13. The mounting members 92 are designed to be a sliding fit within the respective channel 56. The cartridge also includes a clamping member 94 which is generally C-shaped in cross-section, and which is shown in the front and end views of FIGS. 14 and 15. The clamping member 94 is shaped to engage within the channel 56 and to exert a clamping force on a planer blade 96, to clamp the blade to the drum 16. As best shown in FIG. 13, the mounting member 92 includes a rib 98 which extends along a length of the member and which is shaped to engage in a corresponding recess 100 in the blade 96. The rib 98 thus serves for accurately locating the blade 96 relative to the clamping member 92. The clamping member 94 includes a protrusion 102 defining a pivot point about which the clamping member pivots when the cartridge 58 is secured to the drum 16. To facilitate this, the mounting member 92 includes a number of mounting holes 104 and the clamping member 96 a number of mounting holes 106, which align with the holes 104. With the holes 104, 106 so aligned, securing bolts or screws are located extending through the clamping member 94 and mounting member 92 into threaded bores 108 in the drum 16. As the screws are tightened, the clamping member 94 pivots about the protrusion 102 such that a surface 110 of the clamping member 94 clamps the blade 96 against a mounting surface 112 of the mounting member 92. The blade 96 is then correctly and accurately located on the drum 16, ready for use in a planing operation.

Turning now to FIG. 16, there is shown a longitudinal sectional view of a tubular sanding element 114 which may be mounted on the drum 16 in place of the cartridges 58. The sanding element 114 is also shown in the end view of FIG. 17 and is hollow, defining a shaft 116 which receives the drum 16. Additionally, the element 114 optionally also includes two elongate ribs 118 which are shaped to engage in corresponding recesses 120 in the drum. In this fashion, a positive engagement is provided between the sanding element 114 and the drum 16, to restrict slippage in use.

The tool 10 is shown in FIG. 2 during fitting of the planer blade cartridges 58 to the drum 16. When it is desired to change over the tool 10 for use as a sander, the cap assembly 12 is first removed from the housing 14 in the fashion described above, and the cartridges 58 then removed from the recesses 56. The drum 16 is then restrained against rotation and the locking nut 84 released from the shaft 22, following which the second washer 74 is released from the drum 16. The ribs 118 on the element 114 are then aligned with the recesses 120 (if provided), and the element 114 slid onto the drum 16 until an inclined end surface 122 of the element 114 comes into abutment with a corresponding inclined surface 124 on the first washer 70. The O-ring 80 and second washer 74 are then refitted into the drum recess 66, whereupon a further inclined surface 126 on an opposite end of the element 114 comes into abutment with a corresponding surface 128 on the second washer 74. The locking nut 84 is then tightened as described above, clamping the sanding element 114 to the drum 16 and automatically aligning the element 114 correctly on the drum 16 by virtue of the inclined surfaces 122, 124 and 126, 128. The cap assembly 12 may then be refitted to the housing 14, and the tool is then ready for use in a sanding operation.

Turning now to FIGS. 18 and 19, there are shown right side and left side views of a tool in accordance with an alternative embodiment of the present invention, the tool indicated generally by reference numeral 10a. When the terms left and right are used throughout it is assumed that the tool is being viewed from the rear.

The tool 100a is in fact of like construction to the tool 10 of FIGS. 1 to 17, and like components are indicated by the same reference numerals with the addition of the suffix a. The tool 10 thus takes the form of a combined planer and sander, and is shown in FIGS. 18 and 19 with a drum 16a carrying planer blade cartridges 58a.

The drum 16a is mounted in a primary chamber 130 formed in a housing 14a of the tool 10a, and a secondary chamber 132 is also formed in the housing 14a. An opening 134, illustrated in the schematic view of FIG. 20, is formed in a wall 136 of the housing 14a provided between the primary and secondary chambers 130, 132 and opens on to the primary chamber 130. Also, a radial flow impeller 138 is provided in the secondary chamber 132 and generates a negative pressure differential between the primary chamber 130 and the secondary chamber 132. The impeller 138 is driven and rotated by the tool motor via a motor output pulley 142, belt 144 and an impeller drive pulley 146. The belt 144 also serves for driving the drum 16a via a drum drive pulley 148.

The opening 134 is generally elongate, and extends in a direction along a length of the drum 16a. The length of the opening 134 is at least equal to a length of an operative surface of the drum 16a. The operative surface of the drum 16a is that portion of a surface 150 of the drum which actively facilitates removal of material from a workpiece surface, such as the surface 18 shown in FIG. 1. In the illustrated embodiment, the operative surface of the drum is the entire drum surface area as, in this instance, the drum carries planer blade cartridges 58a having blades 96a which extend along the entire length of the drum 16a. The opening 134 is provided on a tangent of the drum 16a, and is in communication with the secondary chamber 132 via a passage 152. The secondary chamber 132 has an outlet 154 which is in communication with a storage bag 156 via an outlet passage 158.

In use, the impeller 138 is driven simultaneously with the drum 16a, generating a flow of air along the outlet passage 158 into the bag 156. This flow of air causes a reduction in pressure of air in the secondary chamber 132 compared to air in the primary chamber 130, thereby generating the negative pressure differential between the primary and secondary chambers 130, 132. In this fashion, material removed from the workpiece surface 18 by the planer blades 96a is drawn from the primary chamber 130, through the opening 134, along the passage 152 and into the secondary chamber 132 as shown by the arrows A in FIG. 20. From there, the material is directed along the outlet passage 158 as shown by the arrow B, and is discharged into the storage bag 156 for collection. This arrangement of the primary chamber 130, secondary chamber 132, opening 154 and impeller 146 provides for effective removal of material from the primary chamber 130 irrespective of whether the tool 10a is being used as a planer or as a sander, and is particularly effective at drawing relatively fine sanding dust from the primary chamber 130.

Although not shown in FIGS. 21 and 22, the tool 10a comprises a cap assembly similar to the cap assembly 12 of the tool 10 described above, for closing an aperture in a wall of the housing 14a. The tool 10a cap assembly would include a cap shaped to cover an end of the secondary chamber 132. In this fashion, access to the secondary chamber 132 for cleaning purposes can be achieved when the cap assembly is released from the housing 14a. Indeed, it will be noted that the cap 42 of the cap assembly 12 of tool 10 includes a cap portion 42 provided for this purpose.

Turning now to FIGS. 21 and 22, there are shown schematic side and perspective views, respectively, of a part of a tool in accordance with a further alterative embodiment of the present invention, the tool indicated generally by reference numeral 10b. The tool 10b is in fact of like construction to the tool 10a of FIGS. 18-20, and like components share the same reference numerals with the addition of the suffix b. Only the substantive differences between the tool 10b and the tool 10a will be described herein in detail.

The tool 10b includes a primary chamber 130b which opens on to a secondary chamber 132b through an opening 134b. The opening 134b is arranged spaced from a tangent of a drum 16b of the tool 10b, and the secondary chamber 132b includes a portion 160 in which an elongate impeller 138b is located. The impeller is out of a flow path extending from the primary chamber 130b to the secondary chamber 132b, and is arranged to generate a flow of air along the secondary chamber 132b towards an outlet 154b and along an outlet passage 158b, as indicated by the arrow C in FIG. 21, and from there into a storage bag (not shown). This flow of air along the secondary chamber 132b causes a negative pressure differential between the primary chamber 130 and the secondary chamber 132 in the fashion described above, drawing removed material from chamber 130, as indicated by the arrow D. As with the tool 10a, the impeller 138b is driven by a motor 140b through a pulleys 142b and 146b, and the drum 16b is driven by a pulley 148b. FIG. 23 illustrates a variation on the tool 10b shown in FIGS. 21 and 22, where an impeller 138c is provided in place of the impeller 138b, and is driven directly by the tool motor.

Turning now to FIG. 24, there is shown a view of a sanding assembly 162 including a drum 16d, the assembly suitable for inclusion in any one of the tools 10, 10a and 10b described above. The drum 16d is designed for providing a sanding function and would be provided in place of the respective drums 16, 16a, 16b of the tools 10, 10a or 10b. The assembly 162 is also shown in FIG. 25, which is a view of the assembly taken at 90 degrees from the view of FIG. 24.

The drum 16d comprises three generally cylindrical drum segments 164, 166 and 168 which together define the complete drum 16d. The segments are each mounted on a drive shaft 22d which carries a key (not shown) which is shaped to engage in corresponding keyways (also not shown) provided in the drum segments 164, 166 and 168. In this fashion, the segments 164, 166 and 168 are restricted against rotation relative to the shaft 22d in use of a tool carrying the assembly 162.

A compressible member in the form of elastomeric O-ring 170 is provided between the adjacent drum segments 164 and 166 and a similar such O-ring provided between the segments 166 and 168, the O-rings 170, 172 located in respective recesses 174, 176 on the segments 164, 166.

A motor output shaft 178 has a cylindrical hub 180 and a generally rectangular section drive key 182, the hub 180 and key 182 shaped to engage in corresponding hub and key recesses 184 and 186 formed in a hub end 188 of the drive shaft 22d. In this fashion, the drum 16d can be released from engagement with the motor for replacement with a drum carrying planer blades, for example, and provides an effective means of transferring drive transmitted from the motor. The drum segment 168 includes a nut recess 190 shaped to receive an O-ring 80d and a locking nut 84d, in a similar fashion to the drum 16 of the tool 10 described above, the nut 84d engaging a threaded portion 86d adjacent an end 28d of the shaft 22d.

In use, the drum segments 164, 166 and 168 are located on the drive shaft 22d, the segment keyways aligned so as permit location of the shaft key therein. A tubular sanding element (not shown) alike to the element 114 shown in FIG. 16 is then located on the aligned segments, the inclined surface 122 of the element 114 abutting against a corresponding surface 192 on the segment 164. The O-ring 80d is then fitted over the shaft end 28d, and the nut 84d loosely threaded onto the shaft 22d. Finally, the shaft 22d is engaged on the motor output shaft 178, following which the drum 16d is locked and the nut 90d tightened in the fashion described above. Tightening of the nut 84d draws the segments 164, 166 and 168 together, compressing the O-rings 170, 172, which expand radially to abut and grip the sanding element. In this fashion, rotation of the sanding element relative to the drum 16d in use of a tool carrying the assembly 162 is restricted. When it is desired to replace the sanding element or to remove the drum 16d from the tool, the above process is repeated in reverse fashion.

An alternative sanding drum is shown in FIGS. 26, 27 and 28, where driving shaft 193 has a driving dog 210, which engages into collar 205. Collar 205 has a tapered surface 211 that engages with a corresponding tapered surface on sanding cylinder 203. The other end of the sanding cylinder 203 is supported by collar 201, on a tapered surface that mirrors surface 211. Rubber washers 202 can be fitted to collars 201 and 205 to improve the seating of sanding cylinder 203. The assembly is held together by locking nut 198.

The alternative planning drum is shown in FIGS. 29, 30 and 31, where the main body 200 slides over shaft 193 and is locked onto drive dog 210 using locking nut 198. The two planer blades 196 are clamped between cartridge parts 197 and 195 which are then secured into drum body 200 using screws 194. Adjustment screws 199 protrude through planning cartridge parts 197 to allow the blades 196 to be adjusted.

The alternative sanding and planning mechanisms shown in FIGS. 26 to 31 allow quicker change of functions without increasing cost significantly.

An alternative end cap arrangement is shown in FIGS. 32, 33 and 34, where 207 is the end cap that locates into main body 209. Accurate and strong location is achieved by a good fit between raised surface 212 on the end cap 207 and recessed surface 213 on the main body. The same result can also be achieved if the raised surface is on body 209, which locates into a recess in end cap 207. Just two fixing screws 206 are enough to secure the end cap 207 in position because of the strong accurate location provided by surfaces 213 and 213. Dowel pins 208 can be used to improve radial location. This end cap arrangement is cheaper to manufacture, yet is still quick to remove.

It will be understood that one or more of the features of the power tools described above may be provided in combination in a single power tool. Accordingly, it will be understood that a tool according to a further embodiment of the invention may combine one or more features of one or more of the tools 10, 10a or 10b described above and shown in the accompanying drawings.

Various modifications may be made to the foregoing without departing from the spirit or scope of the present invention.

1. A power tool comprising:
a tool housing;
a drum adapted for removing material from a surface of a workpiece, the drum adapted to be releasably mounted within the housing;
a drive shaft adapted to drive and rotate the drum relative to the housing, for removing material from the workpiece surface;
an aperture in the tool housing for facilitating location of the drum within, and removal of the drum from, the housing; and
a cap assembly for coupling to the tool housing to close the aperture, the cap assembly adapted to receive an end of the drive shaft to facilitate mounting of the drum within the housing;
wherein the cap assembly comprises a combined clamping and shaft alignment mechanism which is movable between a release position out of engagement with the shaft end and a clamping position in engagement with the shaft end, and wherein the mechanism is arranged to automatically align the shaft and thus the drum on an optimal rotation axis during movement towards the clamping position and further comprising a first clamping member adapted to abut an outer surface of a wall of the housing and a second clamping member adapted to abut an inner surface of the wall of the housing, wherein the mechanism comprises a threaded securing member which, when rotated, draws the first and second clamp members together to clamp the housing wall and wherein the securing member is adapted to receive the shaft end and comprises or carries a bearing within which the shaft end is received, to facilitate rotation of the shaft relative to the/a main part of the securing member.

2. A power tool according to claim 1, wherein the second clamping member comprises a nut threadably coupled to the threaded securing member and which advances or retracts along the securing member when rotated.

3. A power tool according to claim 2, wherein the second clamping member further comprises a plate defining an abutment surface for abutting the housing wall, which plate may be adapted to engage in a slot formed in the housing wall.

4. A power tool according to claim 1, wherein one of the cap assembly and the housing defines an at least one alignment member.

5. A power tool according to claim 4, wherein the at least one alignment member is a rib.

6. A power tool according to claim 5, wherein the other one of the cap assembly and the housing defines a corresponding at least one alignment recess.

7. A power tool according to claim 6, wherein engagement between the alignment member and the recess facilitates alignment of the shaft and drum on the optimal rotation axis.

8. A power tool according to claim 6, wherein the cap assembly comprises a cap shaped to cover the aperture.

9. A power tool according to claim 8, 6, wherein the cap defines one of the alignment member and the recess.

10. A power tool according to claim 9, wherein the other one of the alignment member and the recess is defined by a wall of the housing.

11. A power tool according to claim 9, wherein at least one surface of the alignment member and at least one surface of the recess is inclined.

12. A power tool according to claim 1, wherein a secondary aperture is formed in the housing and the cap assembly further comprises a cap portion adapted to close the secondary aperture.

13. A power tool according to claim 12, wherein the tool further comprises a dust extraction chamber and the secondary aperture opens on to said dust extraction chamber of the tool.

14. A power tool according to claim 1, wherein the drum is located such that a main axis of the drum is perpendicular to a main axis of the tool.

15. A power tool according to claim 1, wherein the aperture is formed in a side wall of the housing.

16. (canceled)

17. A cap assembly for coupling to a housing of a power tool to close an aperture of the tool which aperture facilitates location of a drum within, and removal of the drum from, the housing, the cap assembly also being for receiving an end of a drive shaft of the tool adapted to drive and rotate the drum relative to the tool housing to remove material from a surface of a workpiece, the cap assembly comprising:
a combined clamping and shaft alignment mechanism which is movable between a release position out of engagement with the shaft end and a clamping position in engagement with the shaft end, the mechanism arranged to automatically align the shaft and thus the drum on an optimal rotation axis during movement towards the clamping position and further comprising a first clamping member adapted to abut an outer surface of a wall of the housing and a second clamping member adapted to abut an inner surface of the wall of the housing, wherein the mechanism comprises a threaded securing member which, when rotated, draws the first and second clamp members together to clamp the housing wall and wherein the securing member is adapted to receive the shaft end and comprises or carries a bearing within which the shaft end receivable, to facilitate rotation of the shaft relative to the/a main part of the securing member.

18. (canceled)

19. A power tool for removing material from a surface of a workpiece, the tool comprising:
a tool housing; and
a drum adapted for rotation relative to the housing, the drum comprising an at least one mounting channel for receiving an at least one planer blade to remove material from the workpiece surface in a planing action when the drum is rotated, and the drum being adapted to receive a tubular sanding element which element is located around the drum and which defines a sanding surface for abrading the workpiece surface when the drum is rotated;
wherein, in use, the tool is adapted to be configured for a planing operation by mounting an at least one planer blade in the at least one mounting channel and to be configured for a sanding operation by mounting of a tubular sanding element around the drum.

20. A power tool according to claim 19, wherein the drum is permanently fixed in position.

21. A power tool according to claim 19, wherein the drum comprises a plurality of channels, each channel adapted to receive a respective at least one planer blade.

22. A power tool according to claim 19, wherein the drum is dimensioned to be a close-fit with the tubular sanding element for driving and rotating the element.

23. A power tool according to claim 19, wherein the drum defines an abutment surface for abutment with the tubular sanding element in a friction fit, for driving and rotating the element.

24. A power tool according to claim 19, wherein one of the drum and the tubular sanding element define a drive protrusion.

25. A power tool according to claim 24, wherein the other one of the drum and the tubular sanding element defines a corresponding drive recess to receive the drive protrusion.

26. A power tool according to claim 25, wherein a plurality of drive protrusions and corresponding recesses are provided.

27. A power tool according to claim 19, wherein the tool comprises an at least one blade cartridge adapted to be releasably mounted in the drum recess.

28. A power tool according to claim 27, wherein the blade cartridge comprises a mounting member adapted to be located in the drum channel, an at least one planer blade and a clamping member for clamping the blade to the mounting member.

29. A power tool according to claim 28, wherein the clamping member is configured to exert a clamping force on the blade to clamp the blade to the mounting member.

30. A power tool according to claim 28, wherein the mounting member and the clamping member define respective apertures which apertures align when the clamping member is coupled to the mounting member and the cartridge located in the drum channel.

31. A power tool according to claim 30, wherein the aligned apertures are shaped to receive a locking element for locking the cartridge to the drum.

32. A power tool according to claim 28, wherein the mounting member defines a blade mounting surface shaped to receive the blade, and further comprises a locating protrusion shaped to engage a corresponding locating recess in the blade.

33. A power tool according to claim 32, wherein the clamping member comprises a clamping surface adapted to abut the blade to clamp the blade against the mounting surface of the mounting member.

34. A power tool according to claim 33, wherein the clamping member comprises a protrusion defining a pivot point about which the clamping member pivots when the cartridge is secured to the drum, to exert a compressive clamping load on the blade.

35. A power tool according to claim 19, wherein the tool comprises a drive shaft for driving and rotating the drum.

36. A power tool according to claim 35, wherein the tool further comprises a mounting assembly for mounting the drum on the drive shaft.

37. A power tool according to claim 36, wherein the mounting assembly comprises first and second locating elements.

38. A power tool according to claim 37, wherein the first and second locating elements are adapted to engage respective first and second ends of the drum and to be mounted on the drive shaft for thereby locating the drum on the shaft.

39. A power tool according to claim 36, wherein the mounting assembly further comprises a threaded locking nut adapted to engage a threaded portion of the drive shaft for securing the drum to the shaft.

40. A power tool according to claim 38, wherein the locating elements are dimensioned to be a close-fit on the shaft so as to locate the drum as accurately as possible.

41. A power tool according to claim 40, wherein the locating elements are adapted to engage the tubular sanding element.

42. A power tool according to claim 41, wherein the locating elements comprise abutment surfaces which are inclined relative to an axis of the drum for engaging corresponding surfaces on the tubular sanding element.

43. (canceled)

44. A combination planer and sander assembly for a power tool, the assembly comprising:
at least one planer blade;
a tubular sanding element defining a sanding surface;
a drum having an at least one mounting channel for receiving the at least one planer blade;
wherein the drum is adapted to receive the tubular sanding element, the element located around the drum;
and wherein, in use, the drum is adapted to be configured for a planing operation by mounting of the at least one planer blade in the at least one mounting channel and to be configured for a sanding operation by mounting of the tubular sanding element around the drum.

45. (canceled)

46. A power tool comprising:
a tool housing;
a primary chamber in the housing for receiving a drum adapted for removing material from a surface of a workpiece;
a secondary chamber in the housing;
a radial flow impeller for generating a negative pressure differential between the primary chamber and the secondary chamber, for encouraging material removed from the workpiece surface by the drum to pass from the primary chamber and into the secondary chamber; and
an opening formed in a wall of the housing provided between the primary and secondary chamber and through which opening removed material passes into the secondary chamber;
wherein the opening extends in a direction along a length of the drum, and wherein the dimension of the opening in the length direction of the drum is at least equal to a length of an operative surface of the drum.

47. A power tool according to claim 46, wherein the power tool is a power planer, a power sander or a combination power planer and sander.

48. A power tool according to claim 46, wherein the opening is elongate and arranged on a tangent of the drum.

49. A power tool according to claim 46, wherein the secondary chamber comprises an outlet for passage of removed material from the chamber, and the impeller is arranged to direct material through the outlet.

50. A power tool according to claim 49, wherein the radial flow impeller is located in a flow path extending from the drum, through the opening into the secondary chamber, and from the secondary chamber into and through the outlet.

51. A power tool according to claim 49, wherein the radial flow impeller is located in a portion of the secondary chamber which is isolated from a flow path extending from the drum, through the opening and into the secondary chamber, and from the secondary chamber into and through the outlet.

52. A power tool according to claim 50, wherein the radial flow impeller is arranged to direct a jet or stream of air past the opening and into the outlet, to draw the removed material from the primary chamber through the opening.

53. A power tool according to claim 46, wherein the radial flow impeller comprises a plurality of impeller blades.

54. A power tool according to claim 53, wherein the radial flow impeller further comprises two sets of impeller blades, the sets provided on opposite sides of the impeller.

55. (canceled)

56. (canceled)

57. A power tool according to claim 46, wherein the operative surface of the drum is a portion of a surface of the drum adapted to actively facilitate removal of material from the workpiece surface.

58. (canceled)

59. (canceled)

60. A power tool according to claim 57, wherein the operative surface of the drum is that portion of the drum surface which carries or supports a planer blade or sanding surface, and/or the effective area of the drum over which a material removal activity occurs.

61. (canceled)

62. (canceled)

63. (canceled)

64. (canceled)

65. A power tool according to claim 74, wherein the drum segments are adapted to be located on a drive shaft and to be locked in position by a locking member, whereupon the compressible member is compressed and expanded radially to abut the sanding element or the like.

66. A power tool according to claim 72, wherein the drum comprises three drum segments with compressible members located between the adjacent segments.

67. A power tool according to claim 71, wherein the drum segments together define one of a keyway and a key, for engaging with a corresponding key or keyway on a drive shaft for driving and rotating the drum.

68. (canceled)

69. A power tool according to claim 54, wherein the radial flow impeller is a fan or a propeller.

70. A power tool according to claim 46, wherein the tool comprises a plurality of radial flow impellers.

71. A power tool according to claim 46, wherein the drum comprises a plurality of drum segments which together form the drum.

72. A power tool according to claim 71, wherein each segment is generally cylindrical and comprises a compressible member.

73. A power tool according to claim 72, wherein the compressible member is an elastomeric O-ring, located between adjacent segments, for abutting a material removing element.

74. A power tool according to claim 73, wherein the material removing element is a tubular sanding element.
